(19) United States
(12) Patent Application Publication
(10) Pub. No.: US 2014/0017039 A1
(43) Pub. Date: Jan. 16, 2014

(54) Automatic Book Coil Binding Machine

(71) Applicant: Chou-Chih Chiang, Taichung City (TW)

(72) Inventor: Chou-Chih Chiang, Taichung City (TW)

(73) Assignee: CHUNG SHEEN TECHNOLOGY CO., LTD., Taichung City (TW)

(21) Appl. No.: 13/548,682

(22) Filed: Jul. 13, 2012

(51) Int. Cl. B42B 5/12

(52) U.S. Cl. 412/16

(57) ABSTRACT

An automatic book coil binding machine comprising a table, a driving motor, a paper clipping apparatus, a linkage apparatus, a paper alignment apparatus, a coil guiding apparatus and a coil cutting apparatus is provided. When the paper clipping apparatus is driven by the driving motor and the linkage apparatus to a paper clipping position, the paper alignment apparatus is simultaneously driven to locate at a paper detaching position. The coil guiding apparatus is then driven to a guiding position to lead a coil in. The coil cutting apparatus moves to a cutting position to cut the coil at the predetermined position. Thus, the book and the coils are able to be bound rapidly and precisely.

### BACKGROUND OF THE INVENTION

1. Field of the Invention

The present invention relates to a book binding machine. More particularly, the present invention relates to an automatic book coil binding machine.

2. Description of the Prior Art

In the well-known books, in particular, the loose-leaf books, holes are perforated on a side of the books and equipped with the spiral coil for the convenience of page turning and paper tearing.

Conventionally, in the procedures of equipping the coil into the books, the cutting for the match lines is performed in advance according to the dimensions of the books. After the coil is cut at the predetermined length, the coils would then be manually passed through the holes of the books one by one. However, since the books are printed in large quantities, the manual operations delay the binding procedures and is disadvantageous to mass production.

### SUMMARY OF THE INVENTION

The objectives of this invention is to provide an automatic book coil binding machine which is capable of automatically inserting the coils into the holes of the book and then cutting the coils, so as to enhance the binding efficiency.

To achieve the aforesaid objectives, an automatic book coil binding machine is provided in the present invention. The automatic book coil binding machine is comprised of: a table; a driving motor disposed on the table to output rotating power; a paper clipping apparatus disposed on the table for at least one book being located therein, wherein the paper clipping apparatus is capable of being thrusted to move between a paper clipping position and a releasing position and clipping the book at the paper clipping position; a linkage apparatus connecting to the driving motor and the paper clipping apparatus there between, the linkage apparatus transferring the rotating power into a power driving the paper clipping apparatus moving between the paper clipping position to the releasing position; a paper alignment apparatus connecting to the linkage apparatus and being driven by the linkage apparatus to move between a paper aligning position and a paper detaching position, wherein the paper alignment apparatus is at the paper aligning position for the book being rest thereon, and is at the paper detaching position at a distant from the book; a coil guiding apparatus being able to move between an idling position and a guiding position, wherein the coil guiding apparatus is driven from the idling position to the guiding position to lead a coil in when the paper alignment apparatus is at the paper detaching position; a coil cutting apparatus being able to move between a preparing position and a cutting position, wherein the coil cutting apparatus cuts the coil at the predetermined position when the coil cutting apparatus is at the cutting position.

### BRIEF DESCRIPTION OF THE DRAWINGS

The drawings disclose an illustrative embodiment of the present invention which serves to exemplify the various advantages and objects hereof, and are as follows:

FIG. 1 is the perspective view illustrating the preferred embodiment of the present invention.

FIGS. 2-4 are the perspective views illustrating the embodiment as shown in FIG. 1 under another visual angle.

FIGS. 5-6 are the perspective views illustrating partial elements in the embodiment as shown in FIG. 1.

FIGS. 7-9 illustrate partial elements during the operation in the embodiment as shown in FIG. 1.

FIG. 10 illustrates partial elements during the operation in the embodiment as shown in FIG. 1.

FIG. 11 is the perspective view illustrating partial elements in the embodiment as shown in FIG. 1.

FIG. 11(a) is the partial enlarged view illustrating the embodiment as shown in FIG. 11.

FIGS. 12-13 are the perspective views illustrating partial elements in the embodiment as shown in FIG. 1.

FIGS. 14-17 illustrate the operation in the embodiment as shown in FIG. 1.

### DETAILED DESCRIPTION OF THE PREFERRED EMBODIMENT

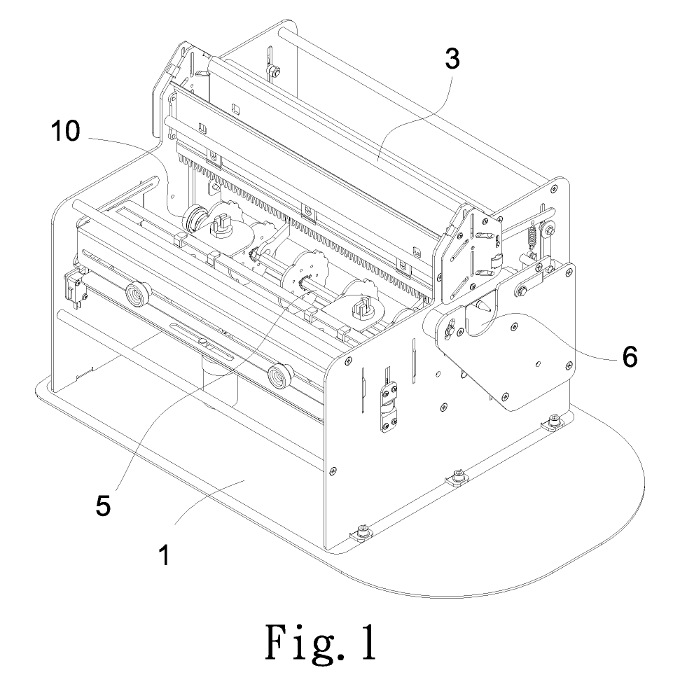

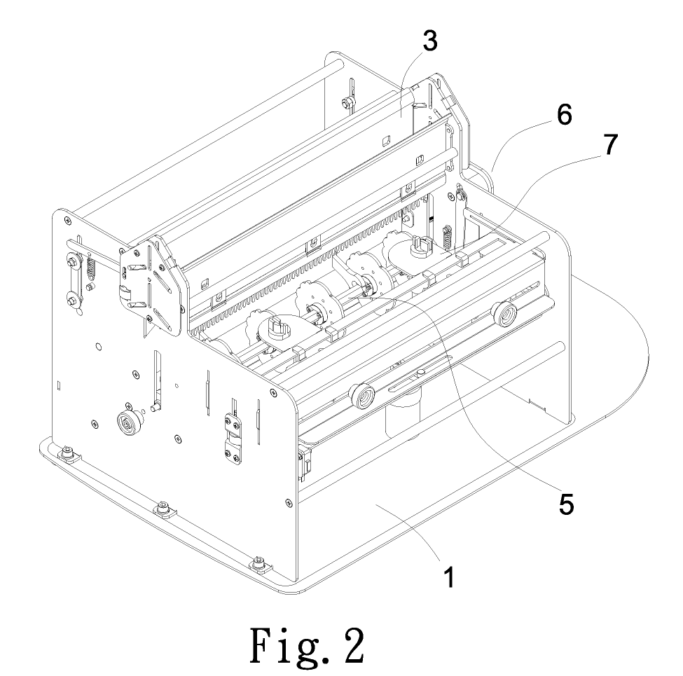

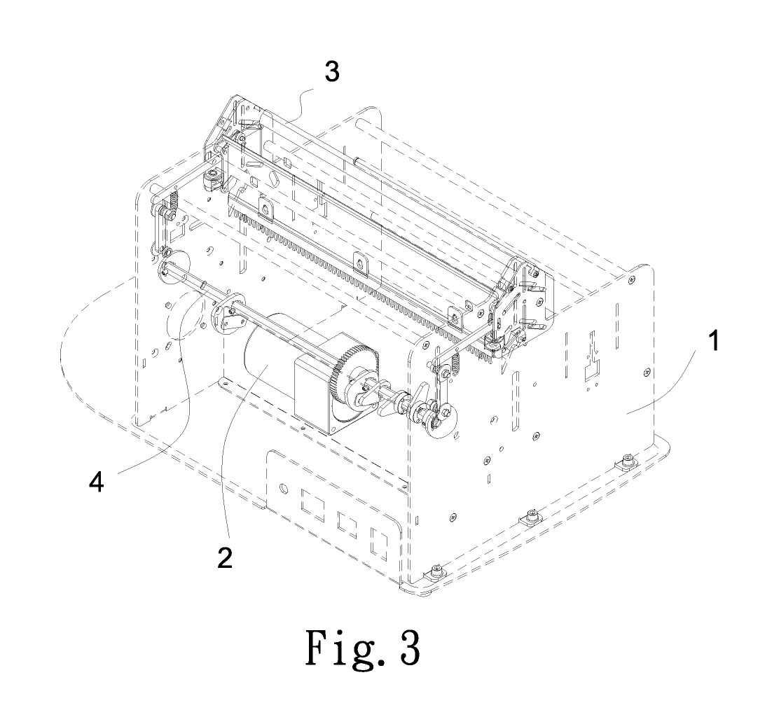

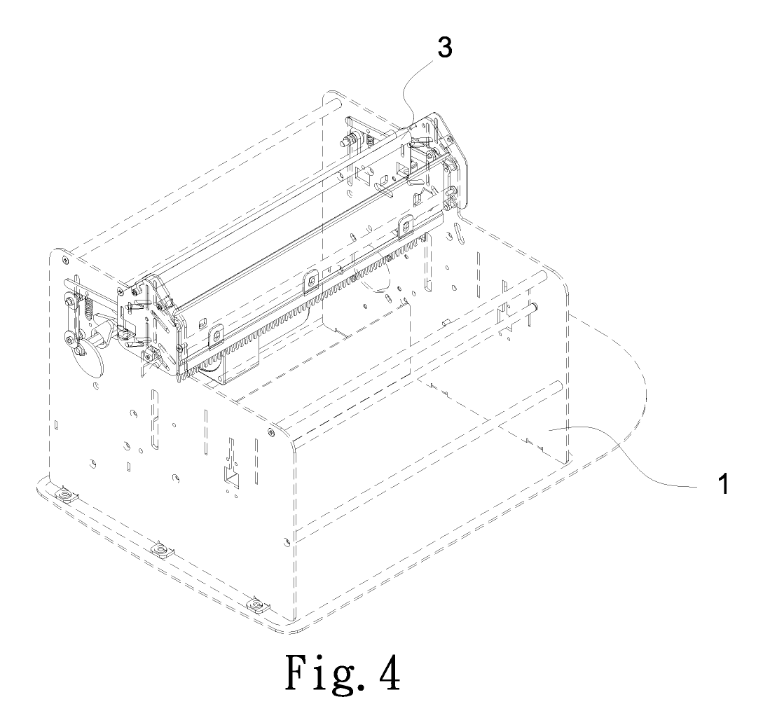

Referring to FIGS. 1-4, the present invention provides an automatic book coil binding machine, which is comprised of a table 1, a driving motor 2, a paper clipping apparatus 3, a linkage apparatus 4, a paper alignment apparatus 5, a coil guiding apparatus 6 and a coil cutting apparatus 7.

The table 1 is capable of being firmly secured on the ground.

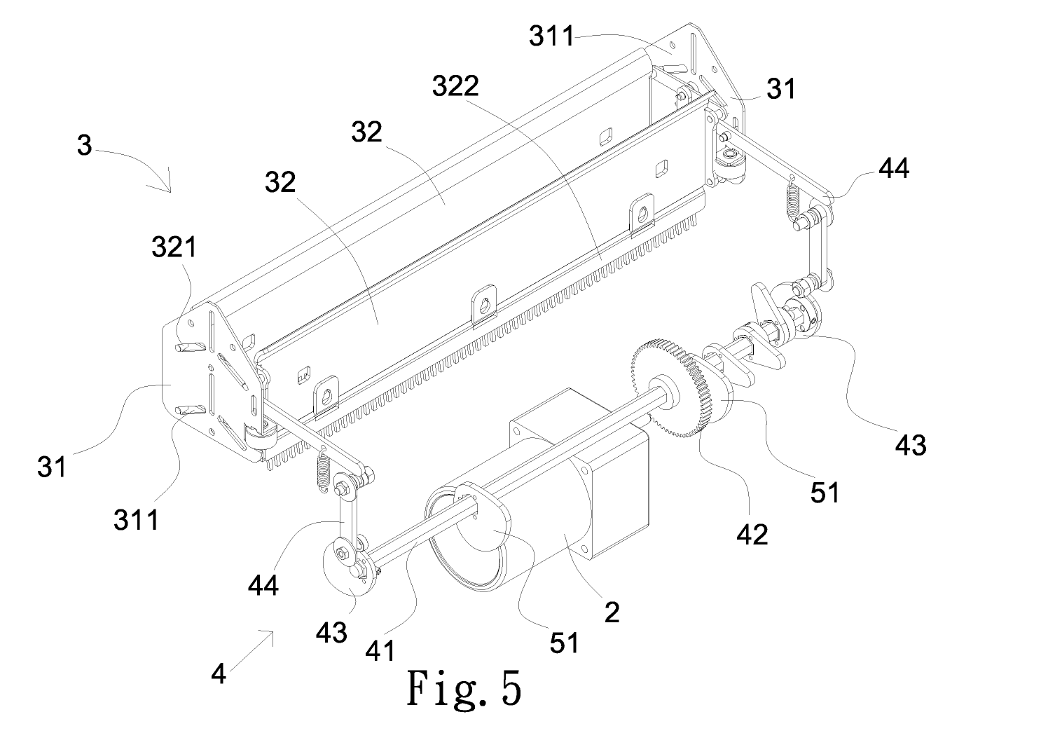

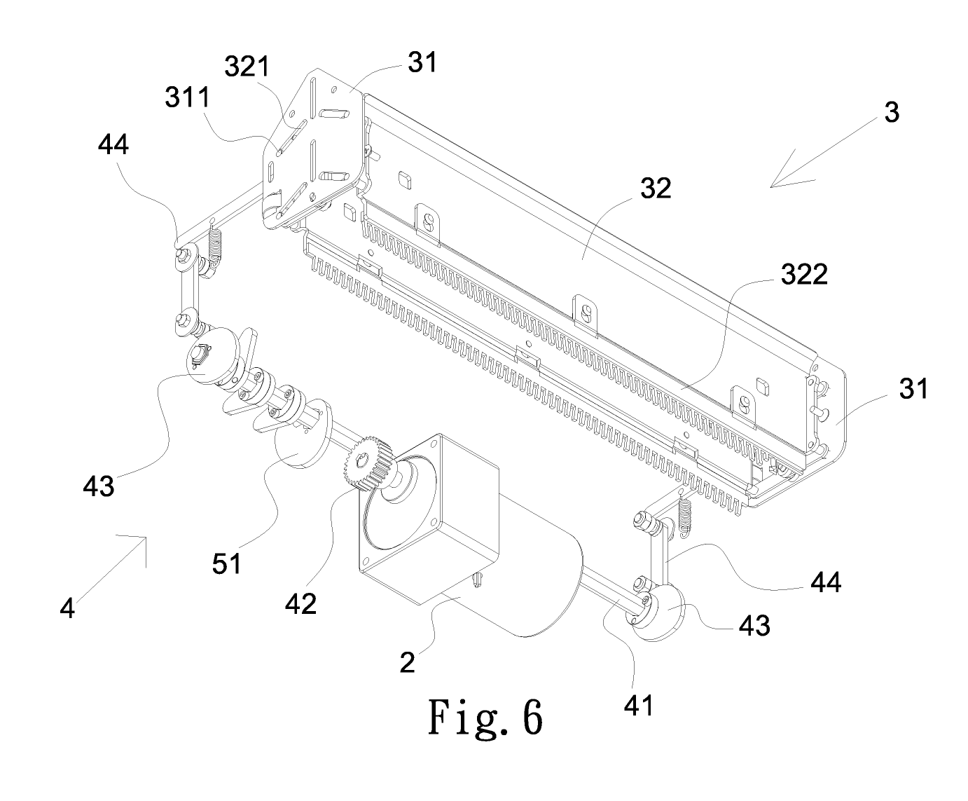

Referring to FIG. 5 and FIG. 6, the driving motor 2 is disposed on table 1 to output rotating power.

The paper clipping apparatus 3 has two fastening boards 31 and two clipping boards 32, wherein the fastening boards 31 are disposed on table 1 and spaced apart with a predetermined interval. Each of the fastening boards 31 is formed with a plurality of guiding skewed slots 311 corresponding to each other. The two clipping boards 32 have two end fringes being formed with a plurality of guiding protrusions 321 in which the guiding protrusions 321 penetrate into the guiding skewed slots 311 so that the two clipping boards 32 are capable of moving between a paper clipping position and a releasing position along the guiding skewed slots 311. Furthermore, a guiding toothed rack 322 is disposed on a bottom fringe of the clipping boards 32.

Referring to FIGS. 5-8, the linkage apparatus 4 connects to the driving motor 2 and the paper clipping apparatus 3 there between. The linkage apparatus 4 transfers the rotating power from the driving motor 2 into the power of driving the two clipping boards 32 of the paper clipping apparatus 3 moving between the paper clipping position to the releasing position.

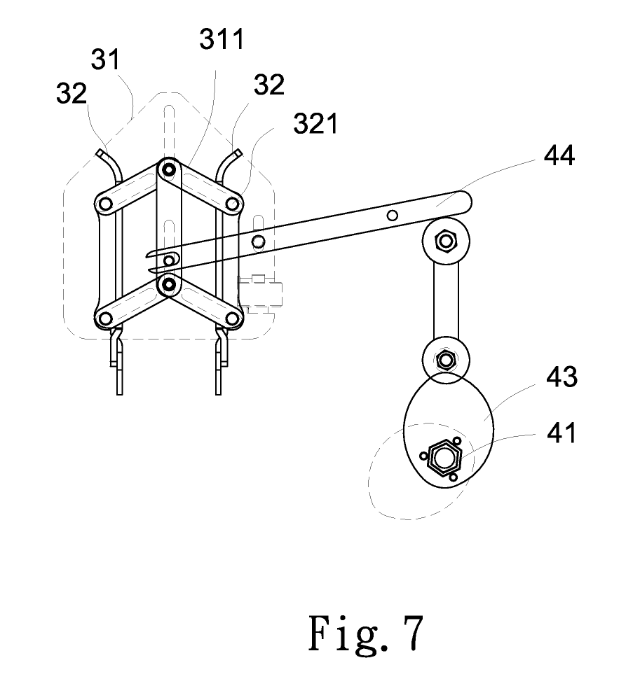

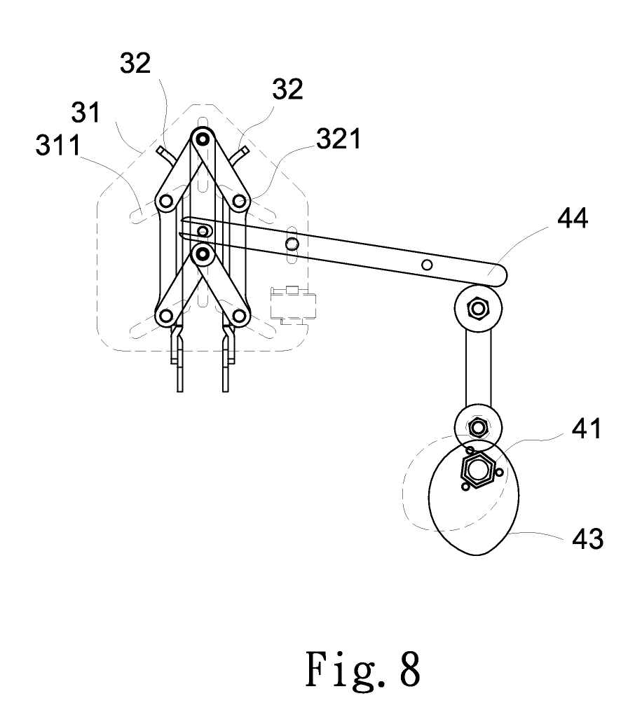

The linkage apparatus 4 has a main shaft 41, a gear set 42 connecting to the main shaft 41 and the driving motor 2, two paper clipping cams 43 connecting to the two ends of the main shaft 41, and two paper clipping linkage sets 44 connecting between the paper clipping cams 43 and the two clipping boards 32 of the paper clipping apparatus 3. When the driving motor 2 outputs rotating power, the gear set 42 transmits the rotating power from the driving motor 2 towards the main shaft 41 for driving the main shaft 41 to rotate, so as to drive the paper clipping cams 43 to eccentrically rotate. The paper clipping cams 43 drive the paper clipping linkage sets 44 to move up and down so that the two clipping boards 32 of the paper clipping apparatus 3 are driven to move between the paper clipping position and the releasing position (as shown in FIGS. 7-8).

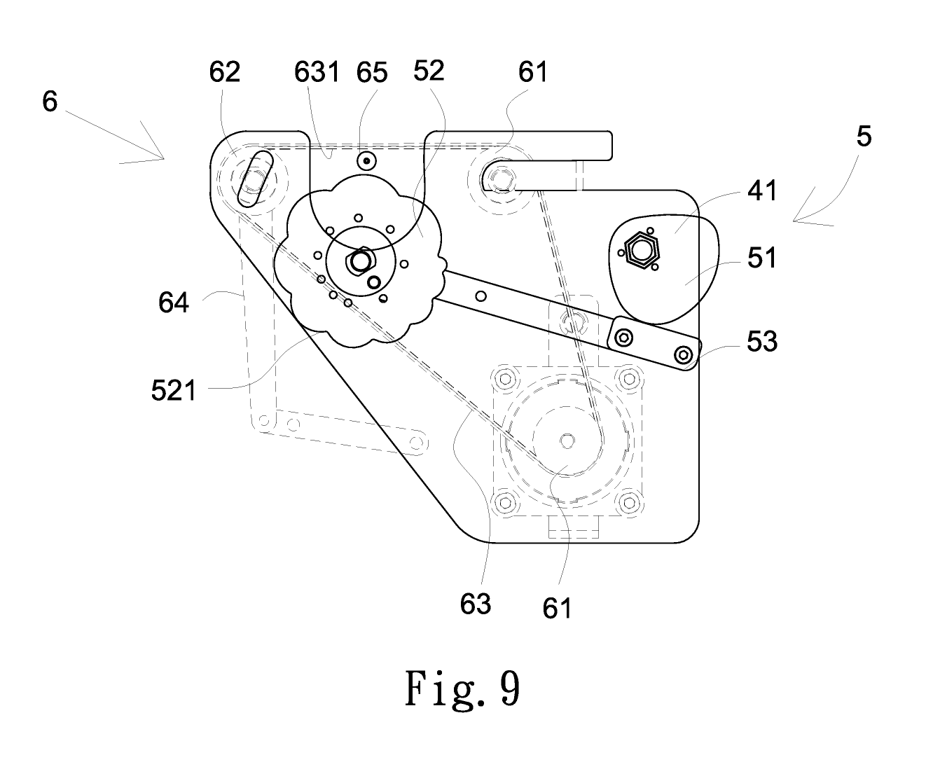

Referring to FIGS. 9-11, the paper alignment apparatus 5 connects to the linkage apparatus 4 so as to be driven by the linkage apparatus to move between a paper aligning position and a paper detaching position. When the paper alignment apparatus 5 is at the paper aligning position, it is provided for the book to rest thereon; whereas when the paper alignment apparatus 5 is at the paper detaching position, it is distant from the book.

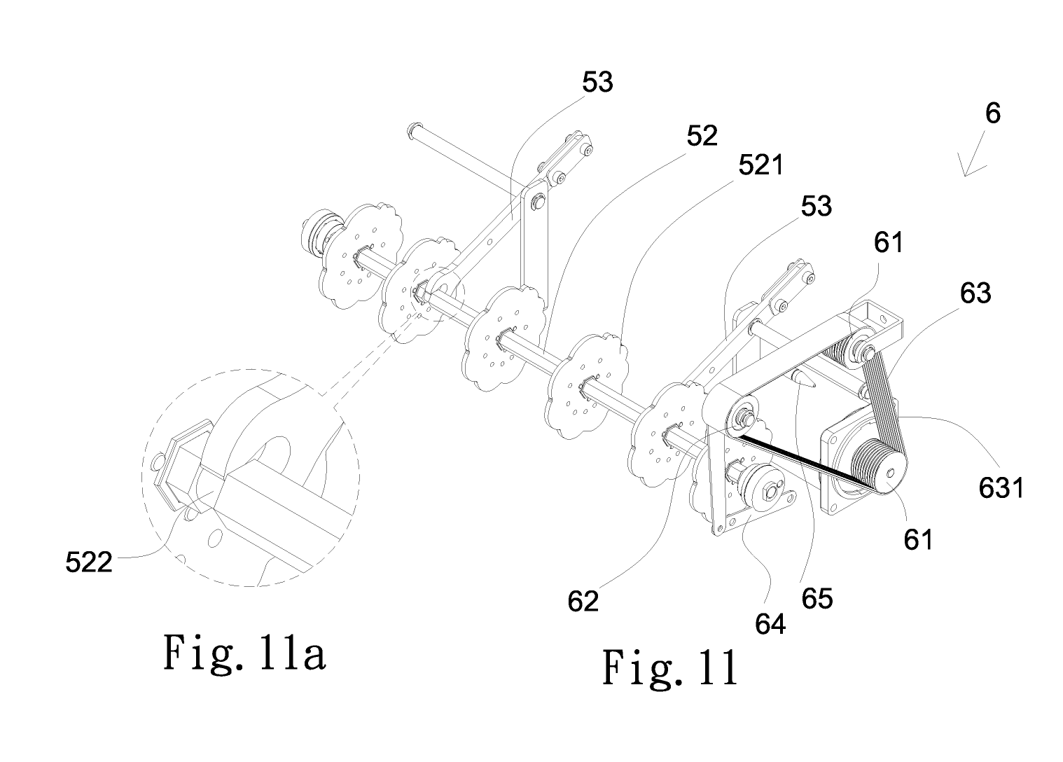

The paper alignment apparatus 5 has two paper resting cams 51, a spline gear shaft set 52 and two connecting rods 53. The paper resting cams 51 are disposed on the main shaft 41 of the linkage apparatus 4. The spline gear shaft 52 is formed with a plurality of spline teeth 521. The two connecting rods 53 are pivotally disposed on the table 1 and is being connected to the spline gear shaft set 52 at an end and against to the paper resting cams 51 at the other end. When the driving motor 2 drives the main shaft 41 of the linkage apparatus 4, the paper resting cams 51 would be driven to rotate simultaneously. Thus, the paper resting cams 51 drives the connecting rods 53 to pivotally swing and the spline gear shaft set 52 to move between the paper aligning position and the paper detaching position (as shown in FIG. 11).

Referring to FIGS. 9-11, the coil guiding apparatus 6 has a plurality of fixed belt pulleys 61 pivoting on the table 1, a movable belt pulley 62 pivoting on the table 1 and being able to move along a predetermined route under an external force, a belt 63 encircling the fixed belt pulleys 61 and the movable belt pulley 62, a driven linkage set 64 connecting to the movable belt pulley 62, and a guiding column 65 disposed within the belt 63. The belt 63 is formed with a plurality of guiding grooves 631 on the inner peripheral surface thereof.

When the paper alignment apparatus 5 is at the paper detaching position, the spline gear shaft set 52 drives the driven linkage set 64 moving downwardly so that the driven linkage set 64 pulls the movable belt pulley 62 from an idling position to a guiding position. The guiding grooves 631 of the belt 63 contact against a coil (not shown in the figures) to lead the coil inwardly.

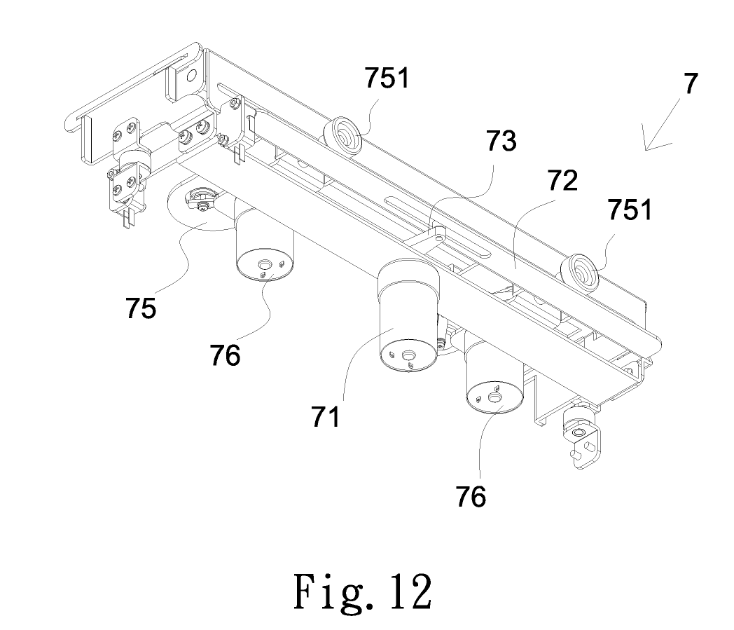

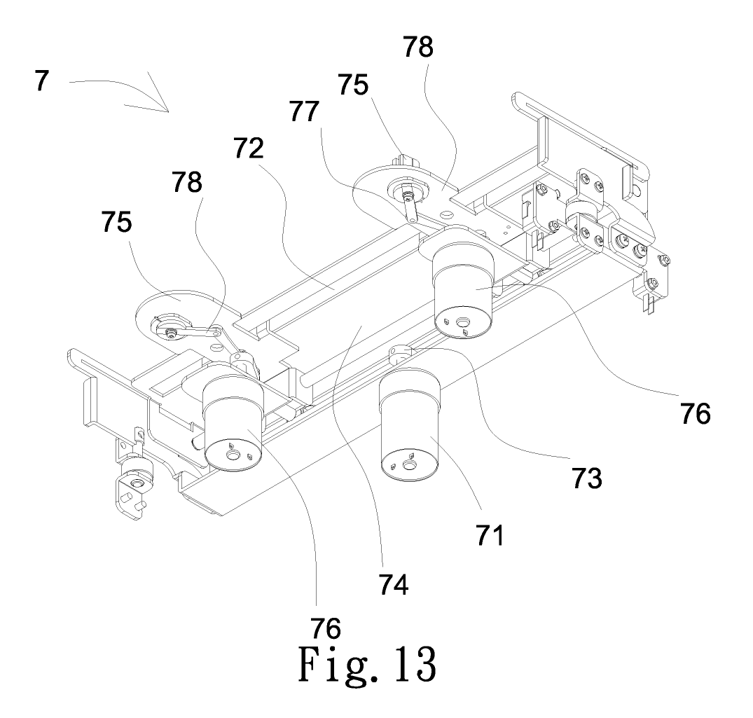

Referring to FIGS. 12-17, the coil cutting apparatus 7 is capable of moving between a preparing position and a cutting position. The coil cutting apparatus 7 is adapted to cut the coil at a predetermined position when the coil cutting apparatus 7 is at the cutting position.

The coil cutting apparatus 7 has a displacement motor 71 which is secured on the table 1, a cutting platform 72 movably disposed on the table 1, a displacement crank 73 connecting with the displacement motor 71 and the cutting platform 72 there between, an adjusting rod 74 disposed on the cutting platform 72, two displacement seats 75 disposed on the adjusting rod 74, two cutting motors 76 respectively disposed on the displacement seats 75, two cutters 77 respectively disposed on the displacement seats 75, and two cutting rod sets 78 respectively connecting with the cutting motors 76 and the cutters 77 there between.

According to the above, the essential components and fabricating processes of the automatic book coil binding machine 100 of the present invention have been disclosed. The operations for the machine are disclosed as follows.

First, the user sleeves a spiral coil (not shown in the figures) onto the guiding column 65 of the coil guiding apparatus 6. Subsequently, the automatic book coil binding machine of the present invention is capable of being started up. The operations for the machine are disclosed as follows.

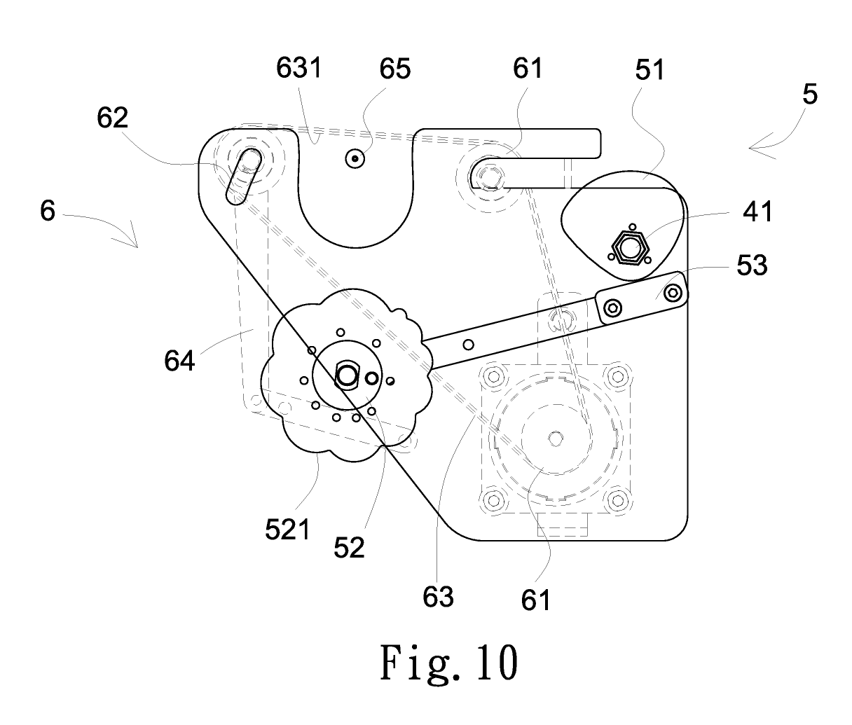

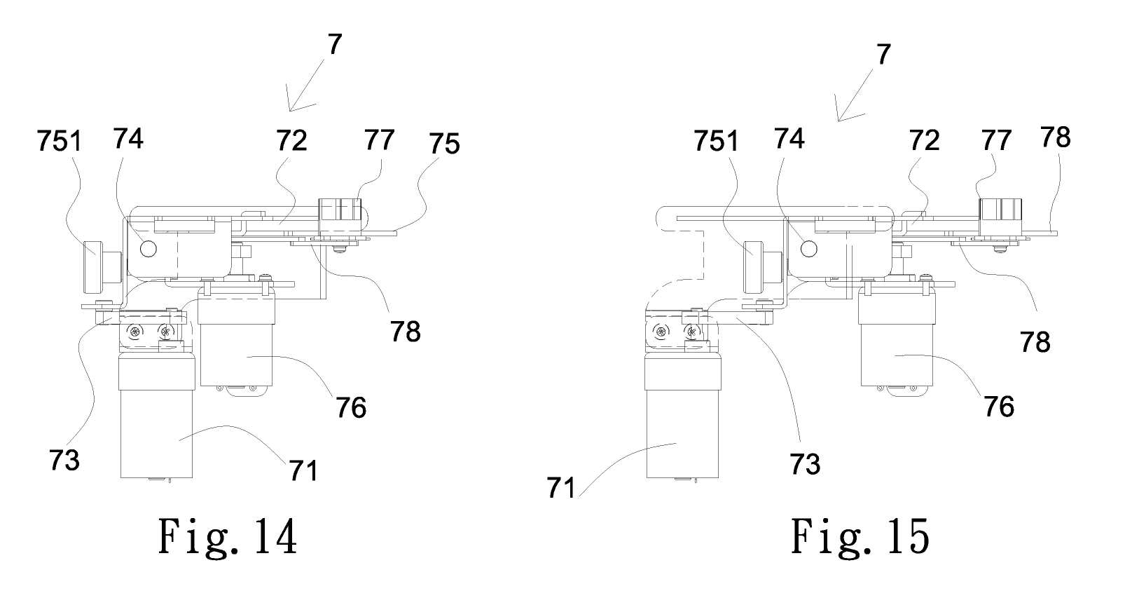

When the driving motor 2 is started up to generate rotating power, the gear set 42 of the linkage apparatus 4 drives the main shaft 41 to rotate, so that the paper clipping cams 43 drive the paper clipping linkage sets 44 to move up and down. The paper clipping linkage sets 44 drive the two clipping boards 32 of the paper clipping apparatus 3 moving along the guiding skewed slots 311 and continuously back and forth between the paper clipping position (as shown in FIG. 8) and the releasing position (as shown in FIG. 7). When the two clipping boards 32 are at the paper clipping position, the book (not shown in the figures) are clipped. Furthermore, when the two clipping boards 32 of the paper clipping apparatus 3 are at the paper clipping position, the paper resting cams 51 of the paper alignment apparatus 5 are simultaneously driven by the main shaft 41 of the linkage apparatus 4. The spline gear shaft set 52 is then driven by the connecting rods 53 to move from the paper aligning position (as shown in FIG. 9), which is provided for the books resting, to the paper detaching position (as shown in FIG. 10). The coil guiding apparatus 6 is also driven by the spline gear shaft set 52 of the paper alignment apparatus 5 to move from the idling position (as shown in FIG. 9) to the guiding position (as shown in FIG. 10). The guiding grooves 631 of the belt 63 would lead the coil inwardly moving along the guiding toothed rack 322 of the paper clipping apparatus 3. At this time, the cutting platform 72 of the coil cutting apparatus 7 also moves from the preparing position (as shown in FIG. 14) to the cutting position (as shown in FIG. 15) due to the rotation of the displacement crank 73 driven by the displacement motor 71. The cutters 77 also cut the coil at a predetermined width due to the pivotal rotation of the cutting rod sets 78 driven by the cutting motor 76. Thus, the book is equipped with the coil with predetermined length so as to achieve the objectives of automatically equipping and cutting the coils onto the books.

Since the machine along with the driving motor 2 of the present invention are continuously operating, the linkage apparatus 4 drives the paper clipping apparatus 3 continuously moving between the paper clipping position to the releasing position. The clipping and releasing for the books are also continuously performed. The paper alignment apparatus 5 continuously moves between the paper aligning position and the paper detaching position so as to drive the coil guiding apparatus 6 to move between the idling position and the guiding position. The coil would be led in with a predetermined length. The coil cutting apparatus 7 moves between the preparing position and the cutting position and continuously cuts the coil at the predetermined length. Thus, the machine of the present invention would be capable of binding the books with coils rapidly and precisely.

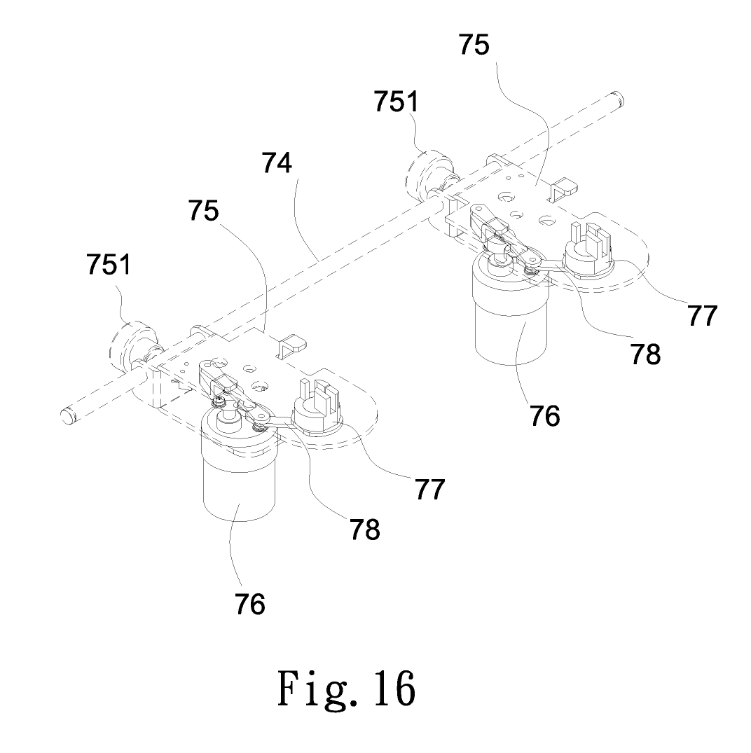

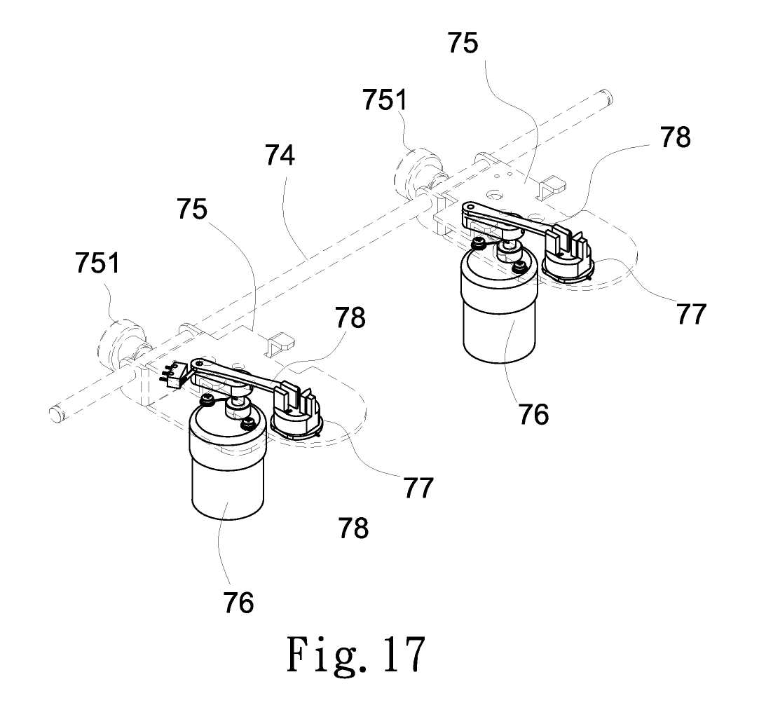

Furthermore, as shown in FIG. 16 and FIG. 17, each of the displacement seats 75 of the coil cutting apparatus 7 has a driving portion 751 to connect with an external tool for adjusting the position where the displacement seat 75 located on the adjusting rod 74. Thus, it would be adjustable according to various books with different width.

Moreover, the spline gear shaft set 52 of the paper alignment apparatus 5 is formed with a circular groove 522 at the position for connecting with the connecting rods 53.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An automatic book coil binding machine, comprising:
a table;
a driving motor disposed on the table to output rotating power;
a paper clipping apparatus disposed on the table for at least one book being located therein, wherein the paper clipping apparatus is capable of being thrust to move between a paper clipping position and a releasing position and clipping the book at the paper clipping position;
a linkage apparatus connecting to the driving motor and the paper clipping apparatus therebetween, the linkage apparatus transferring the rotating power into a power driving the paper clipping apparatus moving between the paper clipping position to the releasing position;
a paper alignment apparatus connecting to the linkage apparatus and being driven by the linkage apparatus to move between a paper aligning position and a paper detaching position, wherein the paper alignment apparatus is at the paper aligning position for the book being rest thereon, and the paper alignment apparatus is at the paper detaching position for being distant from the book;
a coil guiding apparatus being able to move between an idling position and a guiding position, wherein the coil guiding apparatus is driven from the idling position to the guiding position to lead a coil in when the paper alignment apparatus is at the paper detaching position;
a coil cutting apparatus being able to move between a preparing position and a cutting position, wherein the coil cutting apparatus cuts the coil at a predetermined position when the coil cutting apparatus is at the cutting position.

2. The automatic book coil binding machine as claimed in claim 1, wherein the paper clipping apparatus has two fastening boards and two clipping boards, the two fastening boards being disposed on the table and spaced apart with a predetermined interval, each of the fastening boards being correspondingly formed with a plurality of guiding skewed slots, the two clipping boards having two end fringes being formed with a plurality of guiding protrusions penetrating into the guiding skewed slots, the two clipping boards connecting to the linkage apparatus so as to move between the paper clipping position and the releasing position along the guiding skewed slots.

3. The automatic book coil binding machine as claimed in claim 1, wherein each of the clipping boards has a bottom fringe being formed with a guiding toothed rack for leading the coil in.

4. The automatic book coil binding machine as claimed in claim 1, wherein the linkage apparatus has a main shaft, a gear set connecting to the main shaft and the driving motor, two paper clipping cams connecting onto the main shaft, and two paper clipping linkage sets connecting between the paper clipping cams and the paper clipping apparatus, the gear set 42 transmitting the rotating power from the driving motor 2 towards the main shaft 41 for driving the main shaft to rotate so as to drive the paper clipping cams to eccentrically rotate, the paper clipping cams driving the paper clipping linkage sets to move up and down so that the paper clipping apparatus is driven to move between the paper clipping position and the releasing position.

5. The automatic book coil binding machine as claimed in claim 1, wherein the paper alignment apparatus has two paper resting cams, a spline gear shaft set and two connecting rods, the paper resting cams being connected onto the main shaft of the linkage apparatus, the spline gear shaft being formed with a plurality of spline teeth, the two connecting rods pivotally disposed on the table for being connected to the spline gear shaft set at an end and against to the paper resting cams at the other end, when the driving motor drives the main shaft of the linkage apparatus, the paper resting cams being driven to rotate simultaneously so that the paper resting cams drive the connecting rods to pivotally swing and the spline gear shaft set to move between the paper aligning position and the paper detaching position.

6. The automatic book coil binding machine as claimed in claim 5, wherein the spline gear shaft set of the paper alignment apparatus is formed with a circular groove for connecting with the connecting rods.

7. The automatic book coil binding machine as claimed in claim 1, wherein the coil guiding apparatus has a plurality of fixed belt pulleys pivoting on the table, a movable belt pulley pivoting on the table and moving along a predetermined route under an external force, a belt encircling the fixed belt pulleys and the movable belt pulley, a driven linkage set connecting to the movable belt pulley, and a guiding column disposed within the belt for the coil sleeving thereon, the belt being formed with a plurality of guiding grooves on the peripheral surface thereof, wherein the paper alignment apparatus drives the driven linkage set moving downwardly when the paper alignment apparatus is at the paper detaching position so that the driven linkage set pulls the movable belt pulley from the idling position to the guiding position, and the guiding grooves of the belt contact against the coil to lead the coil inwardly.

8. The automatic book coil binding machine as claimed in claim 1, wherein the coil cutting apparatus has a displacement motor, a cutting platform movably disposed on the table, a displacement crank connecting with the displacement motor and the cutting platform therebetween, an adjusting rod disposed on the cutting platform, two displacement seats disposed on the adjusting rod, two cutting motors respectively disposed on the displacement seats, two cutters respectively disposed on the displacement seats, and two cutting rod sets respectively connecting with the cutting motors and the cutters therebetween.

9. The automatic book coil binding machine as claimed in claim 8, wherein each of the displacement seats of the coil cutting apparatus has a driving portion to connect with an external tool for adjusting the position where the displacement seat located on the adjusting rod.
